(19) United States
(12) Patent Application Publication
(10) Pub. No.: US 2007/0260789 A1
(43) Pub. Date: Nov. 8, 2007

(54) Interface transmission structure between modules and method thereof

(75) Inventors: David Ho, Taipei (TW); Jing-Xin Liang, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/637,736

(22) Filed: Dec. 13, 2006

(30) Foreign Application Priority Data
May 5, 2006 (TW) 095116001

(51) Int. Cl. G06F 13/00

(52) U.S. Cl. 710/100

(57) ABSTRACT

An interface transmission structure between modules and its method comprise a central processor installed in an electronic device, a first pin and a second pin installed in the central processor and coupled respectively to a third pin and a fourth pin of at least one module. The central processor is able to receive different voltage amplitudes and to set a plurality of potential levels. The first and second pins respectively output a different output signal to each module according to each potential level, and the output signals are combined into a plurality of command messages, data messages, and status messages. At least one module is also able to receive different voltage amplitudes and to output another output signal according to the different potential levels via the third and fourth pins, and the other output signals are combined into another plurality of data messages and status messages, in order to substitute the conventional data lines, address lines, and control lines and expedite the processing of each message.

### FIELD OF THE INVENTION

The present invention relates to an interface transmission structure and its method, and more particularly to an interface transmission structure between modules and method thereof.

### BACKGROUND OF THE INVENTION

Modern society faces the high-technological information era with increasing advances of the electronics industry. Various high-technological products and mobile transmission devices derived from computers are quickly developed and rapidly becoming essential for daily life. High-technological products and mobile transmission devices can be used to provide even faster communication. Following the high popularity and high utility rate of electronic communication products, such as mobile phones, personal digital assistances (PDA), and portable computers, manufacturers thereof keenly compete with each other in consumer markets to provide many choices to satisfy consumer needs.

With 3G (i.e. third generation digital mobile communication system) times coming, the electronic communication products are provided with more and more functions while more and more processing chips are used, so that the interconnection and allocation of pins for transmitting signals between chips will become more complicated. Furthermore, in consideration of solving problems with electro-magnetic interference (EMI) and electro-magnetic compatibility (EMC), PCB layouts for allocating circuits of the chips will become more difficult to design. Referring now to FIG. 1, a conventional interface transmission structure between a CPU (central processing unit) 600 and a memory unit 200 is taken as an example, wherein a set of address lines 300, a set of data lines 400, and a set of control lines 500 are provided between the CPU 600 and the memory unit 200. The set of control lines 500 are used to transmit various transmission control protocols between the CPU 600 and the memory unit 200. If the transmission control protocols are completed, the set of address lines 300 and the set of data lines 400 will be used to transmit related data.

Traditionally, transmission methods of electronic signals include parallel transmission and serial transmission. Parallel transmission is used to synchronously transmit all bits while the serial transmission is used to transmit bits one by one. The advantage of the parallel transmission is high transmission speed, and the advantage of the serial transmission is only one transmission cable needed so as to lower the repair cost. However, the disadvantage of the parallel transmission is too many transmission cables needed to increase long distance transmission cost and increase the difficulties of allocation and repair. Furthermore, the disadvantage of serial transmission is low transmission speed. Hence, the parallel transmission is generally used to construct a transmission system of relatively shorter distance with high speed requirement while serial transmission is generally used to construct a transmission system of relatively longer distance with low speed requirement.

If the PCB layout of the chips can not be efficiently allocated, the entire volume of the PCB may not be reduced so that the electronic communication products thereof will not be designed compact to compete with other products having similar specifications in the consumer markets. Therefore, it is important to design an interface transmission structure between modules and its method for reducing the size of chip packages and simplifying the PCB layout thereof in order to reduce the entire volume of the electronic communication products.

It is therefore tried by the inventor to develop an interface transmission structure between modules and its method to solve the PCB layout problems about chip allocations existing in the conventional interface transmission structure as described above by means of changing transmission interfaces between chips.

### SUMMARY OF THE INVENTION

A primary object of the present invention is to provide an interface transmission structure between modules, which is applied to an electronic device provided with a central processor having a first pin and a second pin therein respectively coupled to a third pin and a fourth pin of at least one module, wherein the central processor is able to receive different voltage amplitudes and to set a plurality of different potential levels corresponding to the voltage amplitudes, and the first and second pins respectively output a corresponding first output signal to at least one module according to each of the potential levels, and the first output signal thereof can be combined into a plurality of command messages, first data messages, and first status messages, wherein at least one module is able to receive the different voltage amplitudes and to respectively output a corresponding second output signal according to the potential levels via the third and fourth pins, respectively, and the second output signal thereof can be combined into a plurality of second data messages and second status messages for being transmitted to the central processor, so that the present invention can provide various advantages as listed below:
(1) to reduce the use of transmission cables to meet environmental needs;
(2) to reduce the number of pins on the chips to minimize the size of chip packages and the manufacturing cost;
(3) to simplify circuit layouts to speed the design of layout diagrams and printed circuit boards; and
(4) to efficiently minimize the entire volume of the PCB and final products.

A secondary object of the present invention is to provide an interface transmission method between modules, which comprises the following steps of: installing a central processor and at least one module in an electronic device, wherein the central processor has a first pin and a second pin respectively coupled to a third pin and a fourth pin of at least one module; receiving different voltage amplitudes and respectively outputting a corresponding first output signal according to a plurality of different potential levels by the central processor; combining the first output signal thereof into a plurality of command messages, first data messages, and first status messages; receiving the different voltage amplitudes and respectively outputting a corresponding second output signal according to different potential levels by at least one module at least one module; combining the second output signal thereof into a plurality of second data messages and second status messages; when the central processor decides to transmit one of the first data messages to one of at least one module, the central processor determines that the module is not set on a power-saving mode, and commands the module to receive the transmission of the first data message, so that the central processor starts the transmission of the first data message; and when the central processor and the module finish transmission of the first data message without any fault, the central processor and the module are switched into power-saving mode.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a conventional interface transmission structure between a CPU and a memory unit;

FIG. 2 is a block diagram of an interface transmission structure between a central processor and at least one module according to one preferred embodiment of the present invention;

FIG. 3 is a schematic diagram of voltage amplitudes of first status messages according to the preferred embodiment of the present invention;

FIG. 4 is a schematic diagram of voltage amplitudes of second status messages according to the preferred embodiment of the present invention;

FIG. 5 is a code table of status messages according to the preferred embodiment of the present invention;

FIG. 6 is a flow chart of an interface transmission method of first data messages between modules according to one preferred embodiment of the present invention;

FIG. 7 is a flow chart of an interface transmission method of second data messages between modules according to one preferred embodiment of the present invention;

FIG. 8 is a flow chart of an interface transmission method of first data messages between modules according to another preferred embodiment of the present invention;

FIG. 9 is a flow chart of an interface transmission method of second data messages between modules according to another preferred embodiment of the present invention;

FIG. 10a is a schematic diagram of a status message of “wake-up” according to the preferred embodiment of the present invention;

FIG. 10b is a schematic diagram of a status message of “power-saving mode” according to the preferred embodiment of the present invention;

FIG. 10c is a schematic diagram of a status message of “fault exists in second data message determined and received by central processor” according to the preferred embodiment of the present invention; and

FIG. 10d is a schematic diagram of a status message of “fault exists in first data message determined and received by modules” according to the preferred embodiment of the present invention.

### DETAILED DESCRIPTION OF THE PREFERRED EMBODIMENTS

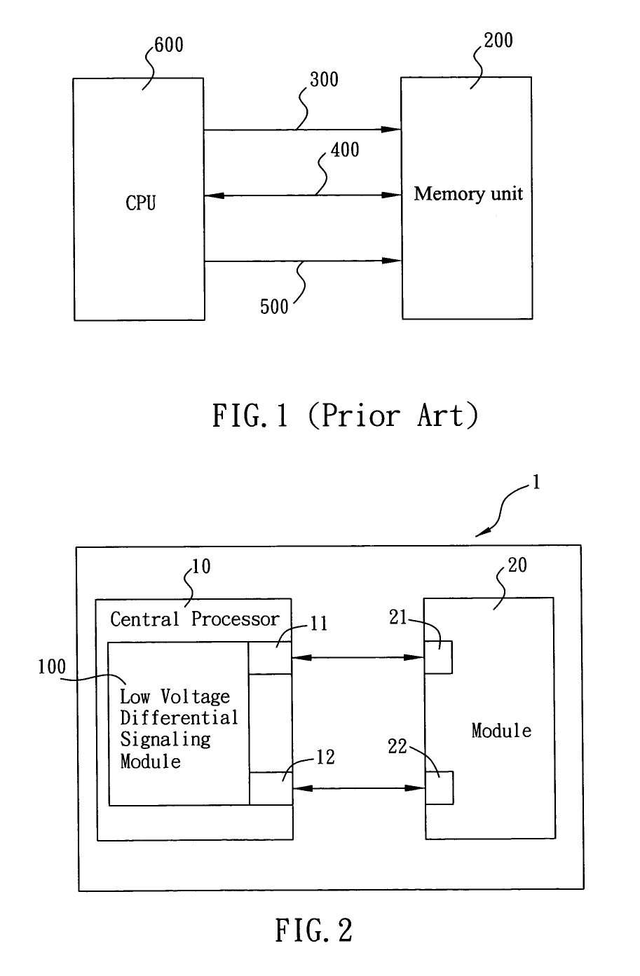

Low Voltage Differential Signaling (LVDS) is a high-efficiency technology applied for transmitting data, which features a low voltage differential signal ranging from 250 mV to 450 mV with fast transition times to address high transmission speed from 100 Mbps to greater than 1 Gbps while providing a low voltage swing to minimize power dissipation. Furthermore, the LVDS technology can be applied to simple linear drivers and receiver physical layer devices as well as more complex interface communication chipsets. The LVDS technology can provide a narrow, high speed, low power LVDS Interface for channel link chipsets, wherein the multiplex and demultiplex transmission of the channel link chipsets would slow TTL (Transistor Logic) signal lines. These chipsets provide dramatic systems savings in cable and connector costs, as well as a reduction in the amount of physical space required for the connector footprint. Referring now to FIGS. 2, 3, and 4, an interface transmission structure between modules according to one preferred embodiment of the present invention is illustrated. As shown, an electronic device 1 is provided with a central processor 10 (CPU) installed therein, and the central processor 10 is formed with an LVDS module 100 therein, a first pin 11, and a second pin 12 thereon. The first pin 11 and the second pin 12 are electrically connected to the LVDS module 100 for transmitting low voltage differential signals. The LVDS module 100 is used to receive different voltage amplitudes and to set a plurality of different potential levels. Meanwhile, the first pin 11 and the second pin 12 respectively output a corresponding first output signal according to each of the potential levels, and the first output signal thereof can be combined into a plurality of command messages 41, a plurality of first data messages 42, and a plurality of first status messages 45. Additionally, the first pin 11 and the second pin 12 are electrically coupled to a third pin 21 and a fourth pin 22 of at least one external module 20, such as a flash memory, respectively, so that the third pin 21 and the fourth pin 22 can be used to receive the command messages 41, the first data messages 42, and the first status messages 45. Furthermore, at least one module 20 is also able to receive the different voltage amplitudes and to output a corresponding second output signal according to the potential levels via the third pin 21 and the fourth pin 22, respectively, and the second output signal thereof can be combined into a plurality of second data messages 51 and a plurality of second status messages 52 for being transmitted to the central processor 10, so as to substitute the conventional data lines 400, address lines 300, and control lines 500 as shown in FIG. 1, and expedite processing each message as described above.

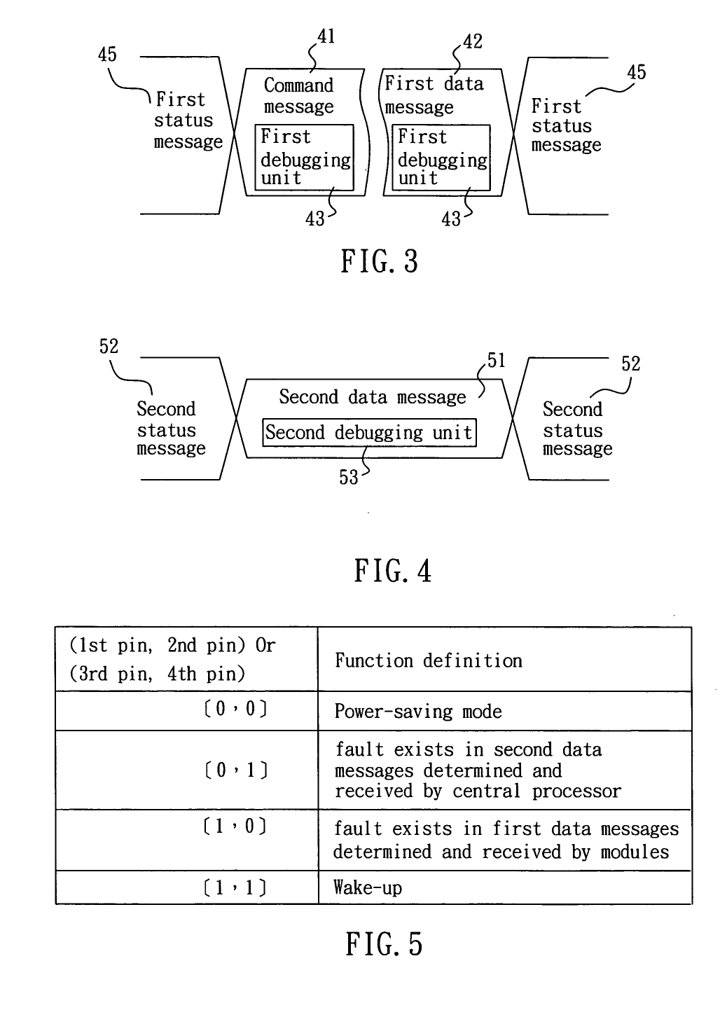

Referring back to FIGS. 2, 3, and 4, the LVDS module 100 of the preferred embodiment of the present invention has a first potential level (not shown), a second potential level (not shown), a third potential level (not shown), and a fourth potential level (not shown) different from each other, wherein the fourth potential level is greater than the third potential level, the third potential level is greater than the second potential level, and the second potential level is greater than the first potential level. The central processor 10 respectively generates the corresponding first output signal according to variation of the second potential level and the third potential level via the first pin 11 and the second pin 12 so that the corresponding first output signal can be combined into the command messages 41 and the first data messages 42, as shown in FIG. 3. Moreover, the central processor 10 respectively generates the corresponding first output signal according to the first potential level and the fourth potential level so that the corresponding first output signal can be combined into the first status messages 45, as shown in FIG. 3. In another aspect, at least one module 20 respectively generates the corresponding second output signal according to variation of the second potential level and the third potential level via the third pin 21 and the fourth pin 22 so that the corresponding second output signal can be combined into the second data messages 51, as shown in FIG. 4. Moreover, at least one module 20 respectively generates the corresponding second output signal according to the first potential level and the fourth potential level so that the corresponding second output signal can be combined into the second status messages 52, as shown in FIG. 4.

Furthermore, in order to minimize power dissipation of the transmission between the central processor 10 and at least one module 20, the central processor 10 and at least one module 20 will be switched into a power-saving mode including a standby mode and an idle mode if being in an inaction status. Referring still to FIGS. 2, 3, and 4, the central processor 10 sends the first output signal according to the first potential level via the first pin 11, and sends the first output signal according to the first potential level via the second pin 12, so that the first output signals are combined into the first status messages 45 which represents to enter the power-saving mode. Moreover, at least one module 20 sends the second output signal according to the first potential level via the third pin 21, and sends the second output signal according to the first potential level via the fourth pin 22, so that the second output signals are combined into the second status messages 52 which represent power-saving mode. Thereby, the central processor 10 and at least one module 20 will enter the power-saving mode, and wait for being woken up. When the central processor 10 transmits messages to at least one module 20 in the power-saving mode, the central processor 10 must wake up at least one module 20 to transmit the command messages 41 and the first data messages 42. Thus, the central processor 10 sends the first output signal according to the fourth potential level via the first pin 11, and sends the first output signal according to the fourth potential level via the second pin 12, so that the first output signals are combined into the first status messages 45 which represents to wake up at least one module 20.

Referring back to FIGS. 2, 3, and 4, the command messages 41 and the first data messages 42 are provided with at least one first debugging unit 43 therein, respectively. At least one first debugging unit 43 is used to allow at least one module 20 to receive the corresponding command message 41 and the corresponding first data message 42 while detecting/checking if any fault exists in the command message 41 and the first data message 42. Therefore, when the module 20 determines that a fault exists in the first data message 42, the module 20 sends the second output signal according to the fourth potential level via the third pin 21, and sends the second output signal according to the first potential level via the fourth pin 22, so that the second output signals are combined into the second status messages 52 which represents that a fault exists in the first data messages 42 determined and received by the module 20. Contrarily, the second data messages 51 are provided with at least one second debugging unit 53 therein, respectively. At least one second debugging unit 53 is used to allow the central processor 10 to receive the corresponding second data message 51 while detecting/checking if any fault exists in the second data message 51. Therefore, when the central processor 10 determines that a fault exists in the second data message 51, the central processor 10 sends the first output signal according to the first potential level via the first pin 11, and sends the first output signal according to the fourth potential level via the second pin 12, so that the first output signals are combined into the first status messages 45 which represents that a fault exists in the second data messages 51 determined and received by the central processor 10.

Referring back to FIGS. 2, 3, and 4, in the preferred embodiment of the present invention, the first output signal sent by the first and second pins 11, 12 of the central processor 10 and the second output signal sent by the third and fourth pins 21, 22 of the module 20 are the first potential levels and the fourth potential levels having potential variations, respectively to generate four combinations as described below. If the first potential level is set on a low voltage status, it defines a code “zero (0)”. If the fourth potential level is set on a high voltage status, it defines a code “one (1)”. Therefore, the present invention defines a code table according to the four combinations, as shown in FIG. 5, so that the central processor 10 and the module 20 can transmit the first status messages 45 and the second status message 52 and communicate with each other.

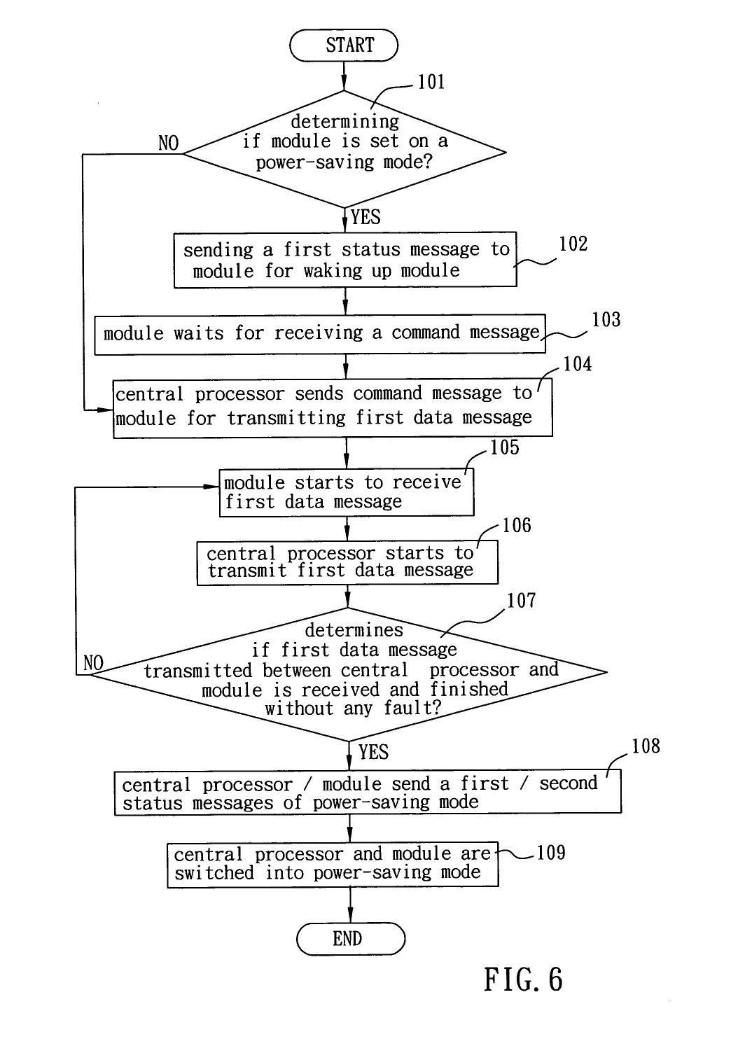

Referring back to FIGS. 2, 3, and 4, an interface transmission method between modules according to one preferred embodiment of the present invention comprises the following steps of: installing a central processor 10 and at least one module 20 in an electronic device 1, wherein the central processor 10 has a first pin 11 and a second pin 12 therein respectively coupled to a third pin 21 and a fourth pin 22 of at least one module 20 by using LVDS technology; receiving different voltage amplitudes and respectively outputting a corresponding first output signal according to a plurality of different potential levels by the central processor 10; combining the first output signal thereof into a plurality of command messages 41, first data messages 42, and first status messages 45; receiving the different voltage amplitudes and respectively outputting a corresponding second output signal according to the different potential levels by at least one module at least one module 20; combining the second output signal thereof into a plurality of second data messages 51 and second status messages 52; when the central processor 10 decides to transmit one of the first data messages 42 to one of at least one module 20, there are several steps described more detailed as the following and shown in FIG. 6:

In step 101, the central processor 10 determines if the module 20 is set on a power-saving mode. If yes, go to step 102; if not, go to step 104;

In step 102, the central processor 10 sends a first status message 45 to the module 20 for waking up the module 20;

In step 103, the module 20 is woken up, and starts to wait for receiving a command message 41;

In step 104, the central processor 10 sends the command message 41 to the module 20 for transmitting the first data message 42 to the module 20;

In step 105, the module 20 receives command message 41, and starts to receive the first data message 42 from the central processor 10;

In step 106, the central processor 10 starts to transmit the first data message 42 to the module 20;

In step 107, the module 20 determines if the first data message 42 transmitted between the central processor 10 and the module 20 is received. If there was no fault go to step 108, otherwise go to step 105;

In step 108, the central processor 10 sends a first status message 45 of the power-saving mode to the module 20 while the module 20 sends a second status message 52 of the power-saving mode to the central processor 10; and

In step 109, the central processor 10 and the module 20 are switched into the power-saving mode.

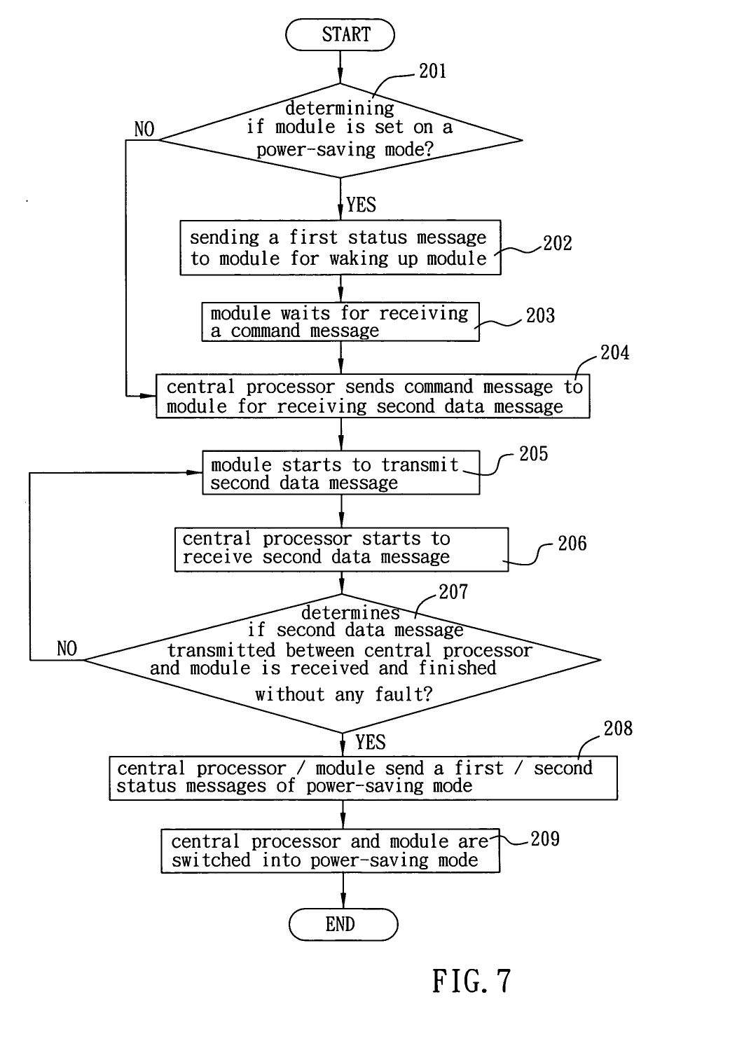

When the central processor 10 decides to receive one of the second data messages 51 from at least one module 20, there are several steps described more detailed as the following and shown in FIG. 7:

In step 201, the central processor 10 determines if the module 20 is set on a power-saving mode. If yes, go to step 202; if not, go to step 204;

In step 202, the central processor 10 sends a first status message 45 to the module 20 for waking up the module 20;

In step 203, the module 20 is woken up, and starts to wait for receiving a command message 41;

In step 204, the central processor 10 sends the command message 41 to the module 20 for receiving the second data message 51 from the module 20;

In step 205, the module 20 receives the command message 41, and starts to transmit the second data message 51 to the central processor 10;

In step 206, the central processor 10 starts to receive the second data message 51 from the module 20;

In step 207, the central processor 10 determines if the second data message 51 transmitted between the module 20 and the central processor 10 is received and finished without any fault. If yes, go to step 208; if not, go to step 205;

In step 208, the central processor 10 sends a first status message 45 of the power-saving mode to the module 20 while the module 20 sends a second status message 52 of the power-saving mode to the central processor 10; and

In step 209, the central processor 10 and the module 20 are switched into power-saving mode.

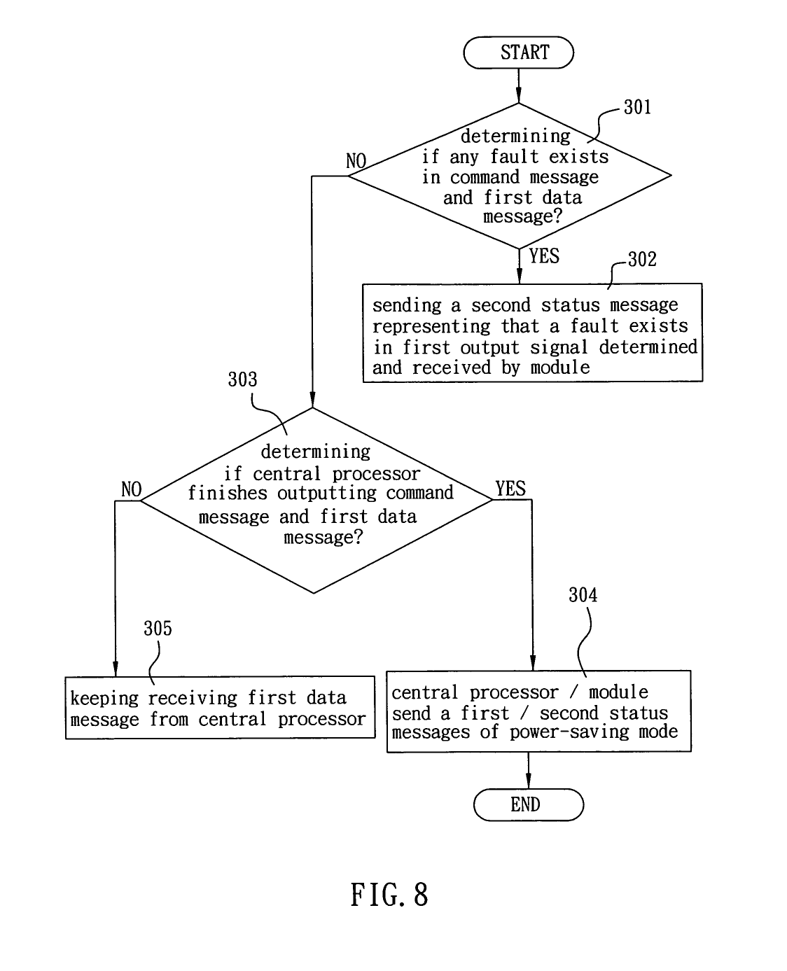

Furthermore, the command messages 41 and the first data messages 42 are provided with at least one first debugging unit 43 therein for checking faults. Referring back to FIGS. 2, 3, and 4, at least one first debugging unit 43 is used to determine if any fault exists in the command messages 41 and the first data messages 42. When the module 20 determines if the transmission of the command messages 41 and the first data messages 42 between the central processor 10 and the module 20 has no fault, there are several steps described more detailed as the following and shown in FIG. 8:

In step 301, the module 20 determines if any fault exists in the received command message 41 and the received first data message 42 via at least one first debugging unit 43. If yes, go to step 302; if not, go to step 303;

In step 302, the module 20 sends a second status message 52 which represents that a fault exists in the first output signal determined and received by the module 20;

In step 303, the module 20 determines if the central processor 10 finishes outputting the command message 41 and the first data message 42. If yes, go to step 304; if not, go to step 305;

In step 304, the central processor 10 sends a first status message 45 of the power-saving mode to the module 20 while the module 20 sends a second status message 52 of the power-saving mode to the central processor 10; and

In step 305, the module 20 keeps receiving the first data message 42 from the central processor 10.

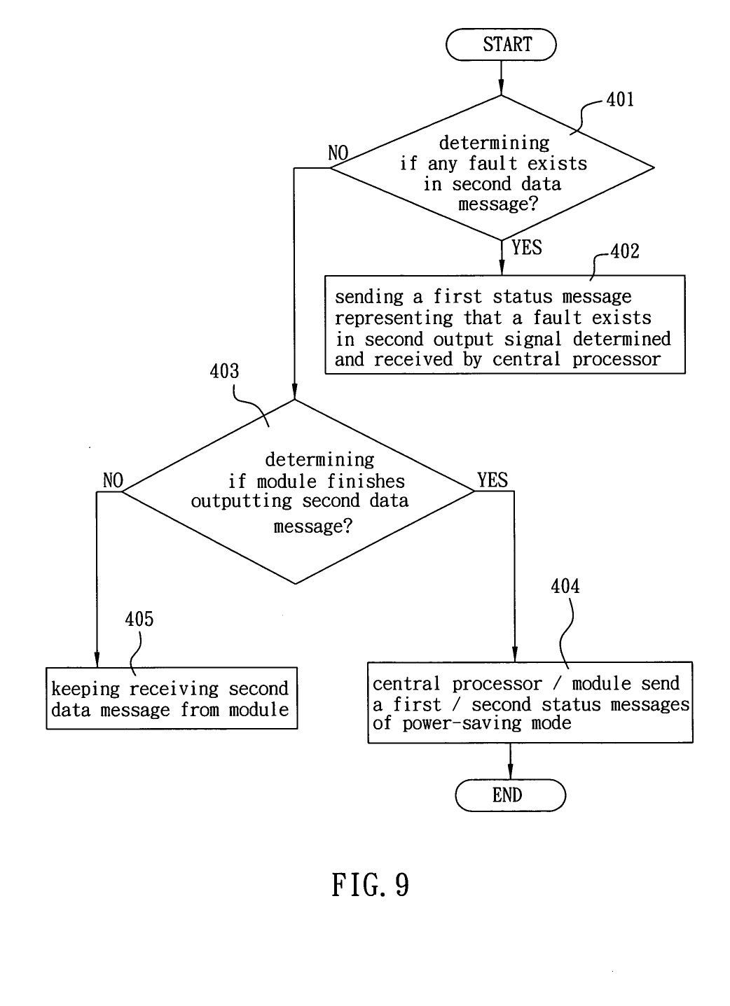

Additionally, the second data messages 51 are provided with at least one second debugging unit 53 therein for checking faults. Referring back to FIGS. 2, 3, and 4, at least one second debugging unit 53 is used to determine if any fault exists in the second data messages 51. When the central processor 10 determines if the transmission of the second data message 51 between the central processor 10 and the module 20 doesn't have any fault, there are several steps described more detailed as the following and shown in FIG. 9:

In step 401, the central processor 10 determines if any fault exists in the received second data message 51 via at least one second debugging unit 53. If yes, go to step 402; if not, go to step 403;

In step 402, the central processor 10 sends a first status message 45 to the module 20, the first status message 45 represents that a fault exists in the second output signal determined and received by the central processor 10;

In step 403, the central processor 10 determines if the module 20 finished transmitting the second data message 51. If yes, go to step 404, otherwise go to step 405;

In step 404, the central processor 10 sends a first status message 45 of the power-saving mode to the module 20 while the module 20 sends a second status message 52 of the power-saving mode to the central processor 10; and

In step 405, the central processor 10 keeps receiving the second data message 51 from the module 20.

Referring still to FIGS. 2, 3, and 4, in one preferred embodiment of the present invention, the central processor 10 (or the module 20) outputs the first output signal (or the second output signal) according to a first potential level, a second potential level, a third potential level, or a fourth potential level via the first pin 11 (or the third pin 21) and the second pin 12 (or the fourth pin 22). Meanwhile, the central processor 10 respectively sends the corresponding first output signal to the module 20 according to variation of the second potential level and the third potential level via the first pin 11 and the second pin 12 so that the corresponding first output signal can be combined into the command messages 41 and the first data messages 42, as shown in FIGS. 3 and 5. Similarly, the module 20 respectively sends the corresponding second output signal to the central processor 10 according to variation of the second potential level and the third potential level via the third pin 21 and the fourth pin 22 so that the corresponding second output signal can be combined into the second data messages 51, as shown in FIGS. 4 and 5.

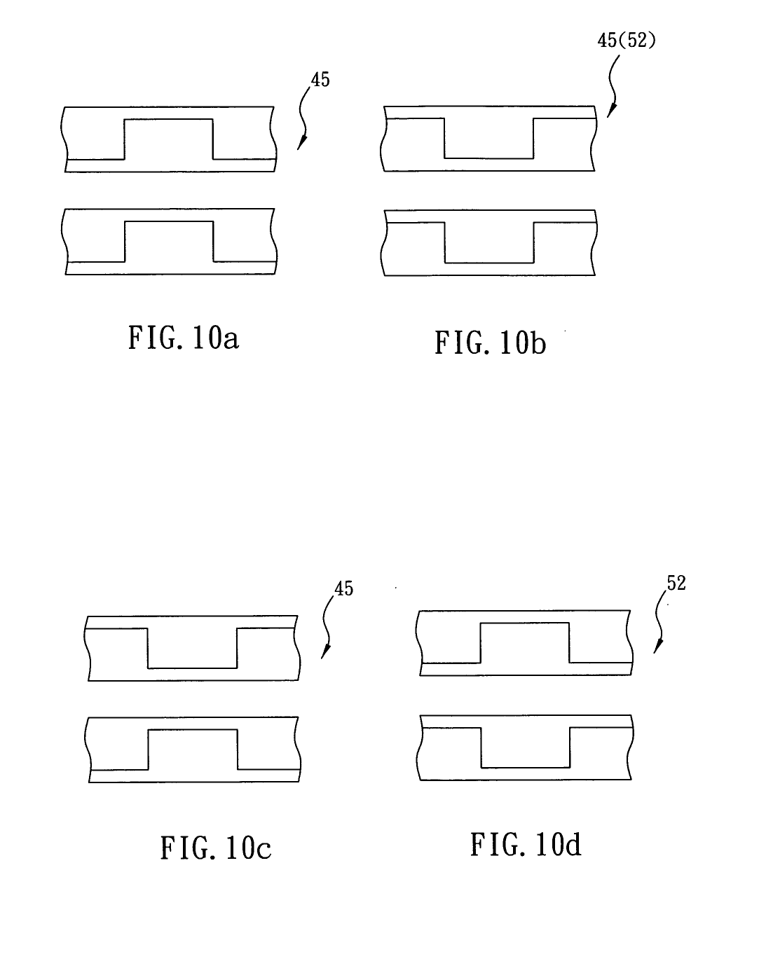

Moreover, the central processor 10 (or the module 20) respectively sends the corresponding first output signal (or the corresponding second output signal) according to the first potential level and the fourth potential level via the first pin 11 (or the third pin 21) and the second pin 12 (or the fourth pin 22) so that the corresponding first output signal (or the corresponding second output signal) can be combined into the first status messages 45 (or the second status messages 52), as shown in FIGS. 3, 4, and 5. Referring to FIG. 10a, when the central processor 10 wants to send a first status message 45 to the module 20 for waking up the module 20, the central processor 10 respectively sends two of the first output signals to the module 20 according to the fourth potential level via the first pin 11 and the second pin 12. After this, the module 20 receives the two first output signals, and is woken up.

Referring to FIG. 10c, when the central processor 10 wants to send a first status message 45, which represents that a fault exists in the second data messages 51 determined and received by the central processor 10, to the module 20, the central processor 10 respectively sends two of the first output signals to the module 20 according to the first potential level and the fourth potential level via the first pin 11 and the second pin 12. After the module 20 receives the two first output signals, the module 20 re-transmits the second data message 51 to the central processor 10.

Referring to FIG. 10b, when the central processor 10 wants to send a first status message 45, which represents to enter the power-saving mode, to the module 20, the central processor 10 respectively sends two of the first output signals to the module 20 according to the first potential level via the first pin 11 and the second pin 12, so that the module 20 receives the first status message 45 which represents that the central processor 10 entered the power-saving status. In another aspect, referring to FIG. 10d, when the module 20 wants to send a second status message 52, which represents to enter the power-saving mode, to the central processor 10, the module 20 respectively sends two of the second output signals to the central processor 10 according to the first potential level via the third pin 21 and the fourth pin 22, so that the central processor 10 receives the second status message 52 which represents that the module 20 entered the power-saving status.

Furthermore, when the module 20 wants to send a second status message 52, which represents that a fault exists in the first data messages 42 determined and received by the module 20, to the central processor 10, the module 20 respectively sends two of the second output signals to the central processor 10 according to the fourth potential level and the first potential level via the third pin 21 and the fourth pin 22. After the central processor 10 receives the two second output signals, the central processor 10 re-transmits the first data message 42 to the module 20.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An interface transmission structure between modules applied to an electronic device, comprising:
a central processor having a first pin and a second pin for respectively outputting a first output signal; and
at least one module having a third pin and a fourth pin respectively connected to the first pin and the second pin for receiving the first output signal, wherein at least one module outputs a second output signal to the central processor according to the first output signal via the third pin and the fourth pin.

2. The interface transmission structure between the modules of claim 1, wherein the first output signal and the second output signal are respectively selected from the group consisting of a first potential level, a second potential level, a third potential level, and a fourth potential level, and wherein the fourth potential level is greater than the third potential level, the third potential level is greater than the second potential level, and the second potential level is greater than the first potential level.

3. The interface transmission structure between the modules of claim 2, wherein the first output signal at least comprises a first status message, a command message, and a first data message, and wherein the first status message is selected from a message representing that a fault exists in the data received by the central processor, a message of a power-saving mode, or a message of a waking-up mode; the command message including the second potential level and the third potential level; and the first data message includes the second potential level and the third potential level.

4. The interface transmission structure between the modules of claim 3, wherein the first status message includes the first potential level and the fourth potential level.

5. The interface transmission structure between the modules of claim 4, wherein the first status message is selected from a message representing that a fault exists in the data received by the central processor, a message of a power-saving mode, or a message of a waking-up mode according to a potential level respectively transmitted by the first pin and the second pin.

6. The interface transmission structure between the modules of claim 3, wherein the command message and the first data message respectively comprise at least one first debugging unit for at least one module to check if a fault exists in the command message and the first data message.

7. The interface transmission structure between the modules of claim 2, wherein the second output signal comprises a second status message and a second data message, and wherein the second status message is selected from a message representing that a fault exists in the data received by at least one module, a message of a power-saving mode, or a message of a waking-up mode; and the second data message includes the second potential level and the third potential level.

8. The interface transmission structure between the modules of claim 7, wherein the second status message includes the first potential level and the fourth potential level.

9. The interface transmission structure between the modules of claim 8, wherein the second status message is selected from a message representing that a fault exists in the data received by at least one module, a message of a power-saving mode, or a message of a waking-up mode according to a potential level respectively transmitted by the third pin and the fourth pin.

10. The interface transmission structure between the modules of claim 7, wherein the second data message respectively comprise at least one second debugging unit for the central processor to check if a fault exists in the second data message.

11. The interface transmission structure between the modules of claim 3, wherein the power-saving mode is a standby or an idle mode.

12. The interface transmission structure between the modules of claim 7, wherein the power-saving mode is a standby or an idle mode.

13. The interface transmission structure between the modules of claim 3, wherein the central processor is provided with a low voltage differential signaling (LVDS) module therein, the LVDS module comprises a plurality of different potential levels, the LVDS module is electrically connected to the first pin and the second pin, and the LVDS module receives different voltage amplitudes and respectively outputs a corresponding first output signal according to each of the potential levels via the first and second pins.

14. An interface transmission method between modules, installing a central processor and at least one module in an electronic device, wherein the central processor has a first pin and a second pin therein respectively coupled to a third pin and a fourth pin of at least one module while the central processor respectively outputs a corresponding first output signal via the first pin and the second pin; wherein at least one module receives the first output signal via the third pin and the fourth pin while at least one module outputs a corresponding second output signal according to the first output signal via the third pin and the fourth pin to the central processor; and wherein the first output signal comprises a first status message, a command message, and a first data message while the second output signal comprises a second status message, and a second data message; the interface transmission method of the first data message comprising steps of:
determining if at least one module is set on a power-saving mode by the central processor;
when at least one module is not set on a power-saving mode by the central processor, sending the command message to at least one module via the central processor for transmitting the first data message to at least one module;
receiving the command message by at least one module;
transmitting the first data message by the central processor;
receiving the first data message from the central processor by at least one module;
determining if the first data message transmitted between the central processor and at least one module is finished by at least one module;
when at least one module is set on a power-saving mode by the central processor, sending the first status message of the power-saving mode to at least one module by the central processor while sending the second status message of the power-saving mode to the central processor by at least one module; and
switching the central processor and at least one module into the power-saving mode.

15. The interface transmission method between the modules of claim 14, wherein after determining if at least one module is set on the power-saving mode by the central processor, if yes, further comprising steps of:
sending the first status message to at least one module for waking up at least one module by the central processor;
waking up at least one module; and
receiving the command message by at least one module while receiving the first data message from the central processor.

16. The interface transmission method between the modules of claim 15, wherein the command message and the first data message respectively comprise at least one first debugging unit to check if a fault exists in the command message and the first data message transmitted between the central processor and at least one module, if yes, further comprises steps of:
transmitting the second status message representing that a fault exists in the determined and received messages by at least one module.

17. The interface transmission method between the modules of claim 14, further comprising a method for receiving the second data message from at least one module by the central processor, comprising steps of:
determining if at least one module is set on a power-saving mode by the central processor;
if not, sending the command message to at least one module by the central processor for receiving the second data message from at least one module;
receiving the command message by at least one module;
transmitting the second data message to the central processor by at least one module;
receiving the second data message by the central processor;
determining if the second data message transmitted between at least one module and the central processor is finished by the central processor;
if yes, sending the first status message of the power-saving mode to at least one module by the central processor while sending the second status message of the power-saving mode to the central processor by at least one module; and
switching the central processor and at least one module into power-saving mode.

18. The interface transmission method between the modules of claim 17, wherein step of determining if at least one module is set on the power-saving mode by the central processor further comprises steps of:
sending the first status message to at least one module for waking up at least one module by the central processor; and
waking up at least one module for transmitting the second data message to the central processor.

19. The interface transmission method between the modules of claim 18, wherein the second data message comprises at least one second debugging unit to check if a fault exists in the second data message transmitted by the central processor and at least one module, if yes, transmitting the first status message representing that a fault exists in the determined and received messages by the central processor.

20. The interface transmission method between the modules of claim 18, wherein the first output signal and the second output signal are respectively selected from the group consisting of a first potential level, a second potential level, a third potential level, and a fourth potential level, and wherein the fourth potential level is greater than the third potential level, the third potential level is greater than the second potential level, and the second potential level is greater than the first potential level.

21. The interface transmission method between the modules of claim 20, wherein the first status message includes the first potential level and the fourth potential level, and the second status message includes the first potential level and the fourth potential level.

22. The interface transmission method between the modules of claim 21, wherein the method of sending the first status message to at least one module for waking up at least one module by the central processor comprises steps of:
transmitting the first output signal including the fourth potential level to at least one module via the first pin by the central processor;
transmitting the first output signal including the fourth potential level to at least one module via the second pin by the central processor;
receiving the two first output signals from the first pin and the second pin by at least one module; and
waking up at least one module.

23. The interface transmission method between the modules of claim 19, wherein the method of transmitting the first status message representing that the fault exists in the determined and received messages by the central processor comprises steps of:
transmitting the first output signal including the first potential level to at least one module via the first pin by the central processor;
transmitting the first output signal including the fourth potential level to at least one module via the second pin by the central processor;
receiving the two first output signals from the first pin and the second pin by at least one module; and
re-transmitting the second data message to the central processor by at least one module.

24. The interface transmission method between the modules of claim 21, wherein the method of transmitting the first status message of the power-saving mode by the central processor comprises steps of:
transmitting the first output signal including the first potential level to at least one module via the first pin by the central processor;
transmitting the first output signal including the first potential level to at least one module via the second pin by the central processor; and
receiving the two first output signals representing that the central processor is switched into the power-saving mode by at least one module.

25. The interface transmission method between the modules of claim 21, wherein the method of transmitting the second status message representing that the fault exists in the determined and received messages by at least one module comprises steps of:
transmitting the second output signal including the first potential level to the central processor via the third pin by at least one module;
transmitting the second output signal including the fourth potential level to the central processor via the fourth pin by at least one module; and
re-transmitting the first data message to at least one module by the central processor.

26. The interface transmission method between the modules of claim 16, wherein the method of transmitting the second status message of the power-saving mode by at least one module comprises steps of:
transmitting the second output signal including the first potential level to the central processor via the third pin by at least one module;
transmitting the second output signal including the first potential level to the central processor via the fourth pin by at least one module; and
receiving the two second output signals representing that at least one module was switched to power-saving mode by the central processor.

27. The interface transmission method between the modules of claim 20, wherein the first data message includes the second potential level and the third potential level, and the second data message includes the second potential level and the third potential level.
